(19) United States
(12) Patent Application Publication
(10) Pub. No.: US 2026/0320027 A1
(43) Pub. Date: Oct. 15, 2026

(54) RECONCILING DATA USING STRUCTURED AND UNSTRUCTURED DATA SOURCES WITH LANGUAGE MODELS AND AGENTIC AI SYSTEMS

(71) Applicant: MASTERCARD INTERNATIONAL INCORPORATED, PURCHASE, NY (US)

(72) Inventors: Gauri Gokul MALWE, Pune (IN); Aakanksha JADHAV, Jersey City, NJ (US); Feyza Ozge SOYKURUM, New York, NY (US); James CONWAY, Dublin (IE); Piyush WADHWA, Pune (IN); Ritik VARSHNEY, Ubale Nagar (IN)

(21) Appl. No.: 19/463,018

(22) Filed: Jan. 28, 2026

(30) Foreign Application Priority Data
Jan. 29, 2025 (IN) 202511007348

(51) Int. Cl. G06F 16/23; G06F 16/2452

(52) U.S. Cl. CPC G06F 16/2365; G06F 16/24522

(57) ABSTRACT

A computerized system and method for reconciling data from structured and unstructured data sources using multiple large language model (LLM) agents is provided. A request to reconcile data is received via a user interface of a virtual assistant. A query is generated by a data engineering agent. The query is executed to obtain first data representing structured data from a database by the data engineering agent. An email agent obtains second data representing unstructured data from messages and/or attachments (e.g., an image, PDF, etc.). A reconciliation agent reconciles the first data and the second data to generate reconciled data. Upon reconciliation, the reconciliation agent updates the status of the data in the database. The reconciled data is outputted in the user interface of the virtual assistant.

### CROSS-REFERENCE TO RELATED APPLICATION

This application claims priority to Indian Provisional Patent Application No. 202511007348, entitled “RECONCILING DATA USING STRUCTURED AND UNSTRUCTURED DATA SOURCES WITH LANGUAGE MODELS AND AGENTIC AI SYSTEMS,” filed on Jan. 29, 2025, the disclosure of which is incorporated herein by reference in its entirety.

### BACKGROUND

Enterprises routinely perform data reconciliation to ensure consistency and accuracy across disparate systems that store structured records such as databases, and unstructured content such as emails, documents, images, and messages. Conventional reconciliation approaches rely heavily on rigid rule-based systems or manual reviews that struggle with incomplete, noisy, or context-dependent data. As business communications increasingly occur through unstructured channels and include semi-structured artifacts such as payment screenshots and scanned documents, these traditional techniques become costly, error-prone, and difficult to scale. While recent advances in large language models offer improved contextual understanding and natural language processing capabilities, existing solutions typically depend on centralized cloud-based deployments that introduce latency, operational cost, and data privacy concerns when processing sensitive data for reconciliation.

### SUMMARY

Some examples provide a computerized method for data reconciliation. The method comprises: receiving, via a user interface of a virtual assistant, a request to reconcile data; generating, by a data engineering agent, a query; executing, by the data engineering agent, the query to obtain first data from a database; obtaining, by an email agent, second data from one or more of messages and attachments; reconciling, by a reconciliation agent, the first data and the second data to generate reconciled data; and outputting, by the reconciliation agent, the reconciled data in the user interface of the virtual assistant.

Some examples provide a computerized method for invoice reconciliation comprising: receiving, via a user interface of a virtual assistant, a request to reconcile one or more invoices; generating, by a data engineering agent, a structured query language (SQL) query; executing, by the data engineering agent, the SQL query to obtain first invoicing data from a database; obtaining, by an email agent, second invoicing data from one or more of messages and attachments; reconciling, by a reconciliation agent, the first invoicing data and the second invoicing data to generate reconciled invoicing data; and outputting, by the reconciliation agent, the reconciled invoicing data in the user interface of the virtual assistant.

Some examples provide a system for invoice reconciliation comprising: a processor; and a memory storing instructions that upon execution by the processor cause the processor to: trigger an invoice reconciliation service comprising a data engineering agent, an email agent, and a reconciliation agent; identify, by the data engineering agent, an invoice data record associated with an invoice with an unpaid status from a database; retrieve, by the data engineering agent, a name of customer from the identified invoice data record associated with the invoice with the unpaid status; identify, by the email agent, a message associated with the name of the customer; summarize, by the email agent, invoicing details from one or more of a body of the identified message and an attachment of the identified message; determine, by the reconciliation agent, that the summarized invoicing details correspond to the invoice with the unpaid status; and based on the determination, automatically update, by the reconciliation agent, the invoice data record in the database by changing the invoice as reconciled.

Some examples provide a computer storage medium storing instructions that upon execution by a processor cause the processor to: analyze a message received in a messaging application; based on the analyzing, determine that the message is a request for confirming reconciliation of an invoice; execute, by a data engineering agent, a SQL query to obtain first invoicing data from a database for the request; obtain, by an email agent, second invoicing data from the message; reconciling, by a reconciliation agent, the first invoicing data and the second invoicing data to generate reconciled invoicing data for the invoice; and automatically send a response to the message, the response including the generated reconciled invoicing data for the invoice.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

The present description will be better understood from the following detailed description read considering the accompanying drawings, wherein:

FIG. 1 is a block diagram illustrating an example system for invoice reconciliation using large language models (LLMs) in a multi-agent system;

FIG. 2A illustrates a multi-agent architecture based invoice reconciliation workflow;

FIG. 2B illustrates data engineering agent architecture used for invoice reconciliation;

FIG. 2C illustrates an example workflow of a data engineering agent architecture, such as illustrated in FIG. 2B;

FIG. 2D illustrates email agent architecture used for invoice reconciliation;

FIG. 2E illustrates an example workflow of an email agent architecture, such as illustrated in FIG. 2D;

FIG. 3A is an example workflow of an invoicing assistant for invoice reconciliation;

FIG. 3B is an exemplary customer details schema;

FIG. 3C is an exemplary invoice details schema before invoice reconciliation;

FIG. 3D is an exemplary payment transaction details schema;

FIG. 3E is an exemplary invoice details schema post invoice reconciliation;

FIG. 3F is an example screenshot of an email requesting payment confirmation for an invoice with invoice details in content of the email message;

FIG. 3G is an example screenshot of an email requesting payment confirmation for an invoice with invoice details in an attachment of the email;

FIG. 3H is an example screenshot of an automated email response for the request in FIG. 3F;

FIG. 3I is an example screenshot of an automated email response for another request for confirmation of payment;

FIG. 3J is an example of email data used by email agent;

FIG. 3K is an example screenshot of an email attachment processed by the email agent;

FIG. 3L illustrates evaluation results for success rate (%), indicating the percentage of tasks successfully completed by each model;

FIG. 3M illustrates evaluation results for Mean Execution Time (s), reflecting the average processing time per task;

FIG. 3N illustrates evaluation results for Energy per Task (Joules), showing the total energy consumption for processing a single task;

FIG. 3O illustrates evaluation results for Performance-to-Power Ratio (%/J), a measure of model efficiency in terms of task success relative to energy consumption;

FIG. 4A illustrates a LangGraph-based agentic workflow for invoice reconciliation;

FIG. 4B is a flowchart illustrating an example method for invoice reconciliation using a multi-agent system; and

FIG. 5 illustrates an example computing apparatus as a functional block diagram.

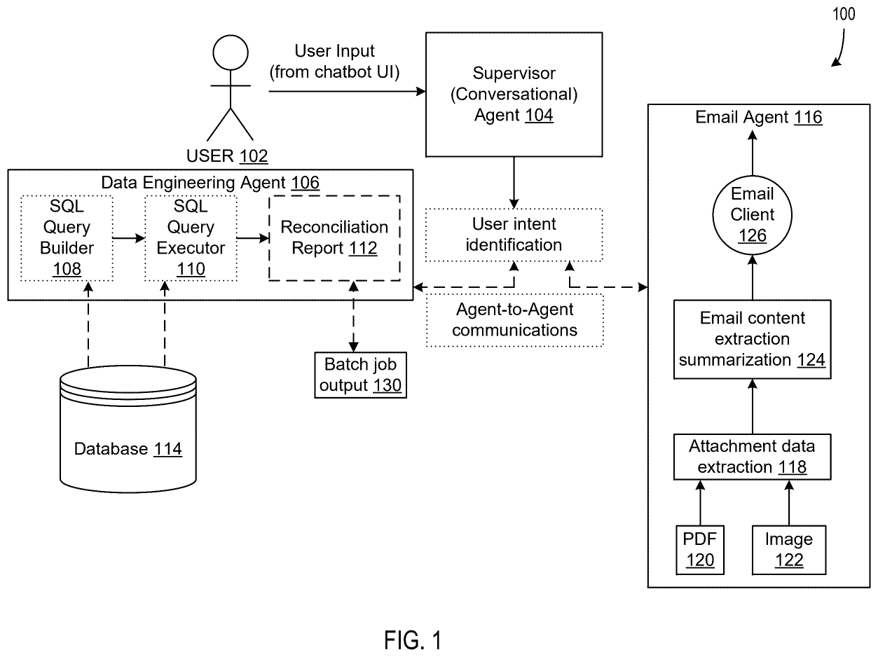

Corresponding reference characters indicate corresponding parts throughout the drawings. In FIGS. 1 to 5, the systems are illustrated as schematic drawings. The drawings may not be to scale. Any of the figures may be combined into a single example or embodiment.

### DETAILED DESCRIPTION

Large language models (LLMs) have revolutionized and transformed business operations through agent-based workflows, offering advanced capabilities in logic processing, contextual understanding, and task execution. However, implementing multi-agent workflows faces significant challenges, including high computational demands, elevated costs, data privacy concerns, and the lack of mature agentic frameworks.

Examples of this disclosure provide data reconciliation functionality using structured and unstructured data sources with language models (e.g., edge-deployed LLMs) and agentic artificial intelligence (AI) systems. This disclosure addresses the critical challenges resource efficiency, data privacy, and cost-effectiveness while delivering high accuracy in reconciliation tasks. By leveraging localized LLM deployments and efficient agent coordination, examples of the disclosure perform error free data reconciliation, such as reconciliation of payment transactions at scale.

Examples of the disclosure enhance the data reconciliation process by leveraging advanced open-source LLM-based agents. The system employs multiple agents within a multi-agent framework, enabling efficient and seamless communication among these agents. By utilizing optimized edge LLMs, the computational overhead typically associated with large language models is reduced. Local deployment ensures sensitive data remains within the organizational control, addressing data privacy concerns associated with cloud-based solutions. Examples of the disclosure minimize operational costs by reducing dependency on cloud-based LLM services. The multi-agent architecture enables parallel processing and efficient handling of varying workloads enhancing scalability of the system performing automated data reconciliations in real-time or near real-time.

While some examples are described herein with reference to invoice reconciliation, aspects of the disclosure are operable with any data reconciliation tasks (e.g., inventory reconciliation, supply chain and logistics reconciliation, data integrity and master data reconciliation, etc.). Further, while some embodiments are described with reference to structured query language (SQL) queries, aspects of the disclosure are operable with any form of query.

In some examples, a computerized method performs invoice reconciliation. A request to reconcile one or more invoices is received via a user interface of a virtual assistant. An SQL query is generated by a data engineering agent. The SQL query is executed to obtain first invoicing data from a database by the data engineering agent. The first invoicing data includes customer data, invoice data, and transactions data. An email agent obtains second invoicing data from one or more of messages and attachments. The messages include one or more of an email message, an instant message, and a voice message. The attachments include one or more of an image and a portable document format (PDF) file.

A reconciliation agent reconciles the first invoicing data (e.g., structured data such as from an invoicing database) and the second invoicing data (e.g., unstructured data such as emails, attachment files like an image, PDF, etc.) to generate reconciled invoicing data. In some examples, the reconciliation comprises determining that the first invoicing data and the second invoicing data belong to a same invoice. This invoice has an unpaid status in the first invoicing data. Upon reconciliation, the reconciliation agent updates the status of the invoice from unpaid to reconciled in the database based on finding evidence from the second invoicing data that emails and payment confirmation images exist corresponding to the first invoicing data. The reconciled invoicing data is outputted in the user interface of the virtual assistant. In some examples, the request to reconcile the one or more invoices is received in a first portion of the user interface and the reconciled invoicing data is outputted in a second portion of the user interface. In some examples, a location of the second portion of the user interface is dynamically selected based on the output of the reconciliation. For example, the second portion is located prominently (e.g., top of screen) for user review if an issue has been determined with the reconciled invoicing data.

In some examples, the first portion of the user interface enables receiving a request to update the reconciled invoicing data. Based on the request to update the reconciled invoicing data, updated reconciled invoicing data is outputted by the reconciliation agent in the user interface (e.g., the second portion of the user interface) of the virtual assistant. In some examples, a request to generate a response to a user related to the reconciled invoicing data is received via the user interface of the virtual assistant. The email agent generates the response and automatically sends the generated response to the user related to the reconciled invoicing data. In this way, the functionalities of requesting reconciliation of invoices, reconciling the invoices using multiple agents, viewing the reconciliation status, and sending the response for reconciliation from a remote user (e.g., a customer) are advantageously performed transparently by the virtual assistant by invoking multiple agents or LLMs customized to perform their specific functionality. In this disclosure, the terms ‘agent’ and ‘LLM’ are used interchangeably.

In some examples, the messages are analyzed and based on the analyzing, it is determined that a response is requested by a user (e.g., a customer) for an invoice of the one or more invoices. The email agent generates the response to the user for the invoice based on the reconciled invoicing data and automatically sends the generated response to the user for the invoice.

FIG. 1 is a block diagram illustrating an example system 100 for invoice reconciliation using LLMs in a multi-agent system. A user input is received from a user 102 (e.g., from a chatbot user interface (UI)) by a supervisor agent 104 (e.g., a conversational agent or a virtual assistant). User intent is identified from the user input by the supervisor agent. The identified user intent is passed to a data engineering agent 106. The data engineering agent 106 uses a SQL query builder tool 108 to generate a SQL query using the identified user intent. The SQL query is executed by a SQL query executor tool 110 that obtains invoicing data (e.g., first invoicing data) from a database 114. In some examples, the database 114 comprises a customer database, an invoice database, and a payment transactions database.

The identified user intent is also passed to an email agent 116. The email agent 116 obtains messages and attachments related to the user intent. An attachment data extraction tool 118 extracts data from attachments (such as PDF 120, image 122, etc.). An email content extraction and summarization tool 124 summarizes the data extracted from the attachments and content of the messages. The summarized data comprises invoicing data (e.g., second invoicing data) that is provided to the email agent 116 by the email client 126.

The email agent 116 and the data engineering agent 106 perform agent to agent communications. Based on this agent to agent communications, a reconciliation report 112 is generated using the first invoicing data and the second invoicing data (e.g., as a batch job output 130 at predetermined time, such as every night at 2:00 am). The reconciliation report 112 may be generated by a reconciliation agent (not shown in FIG. 1) different from the data engineering agent 106.

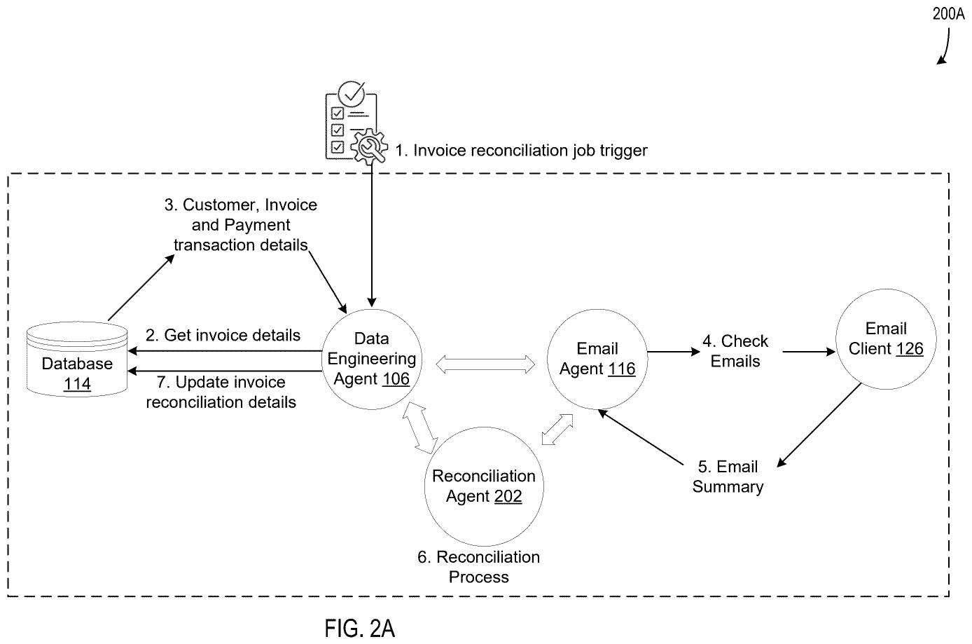

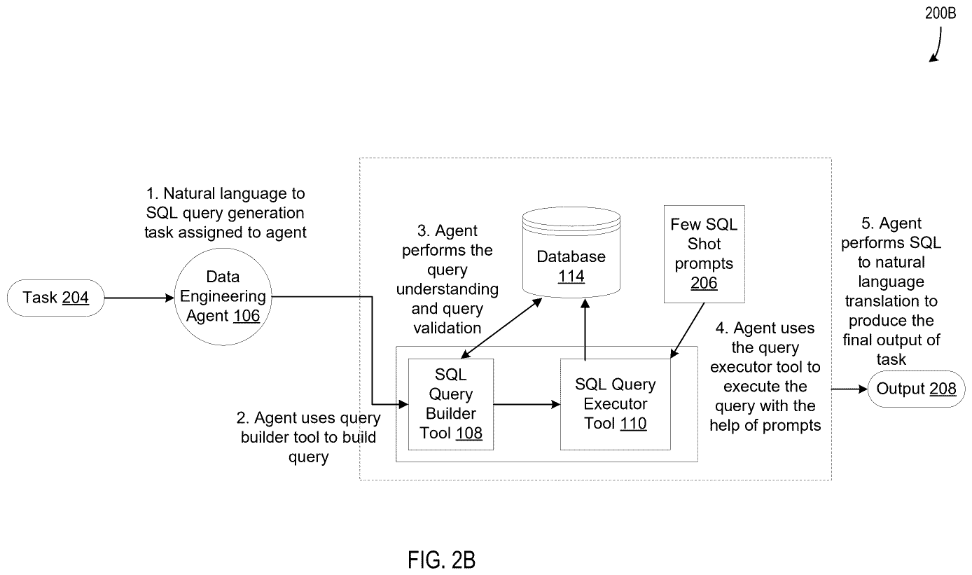

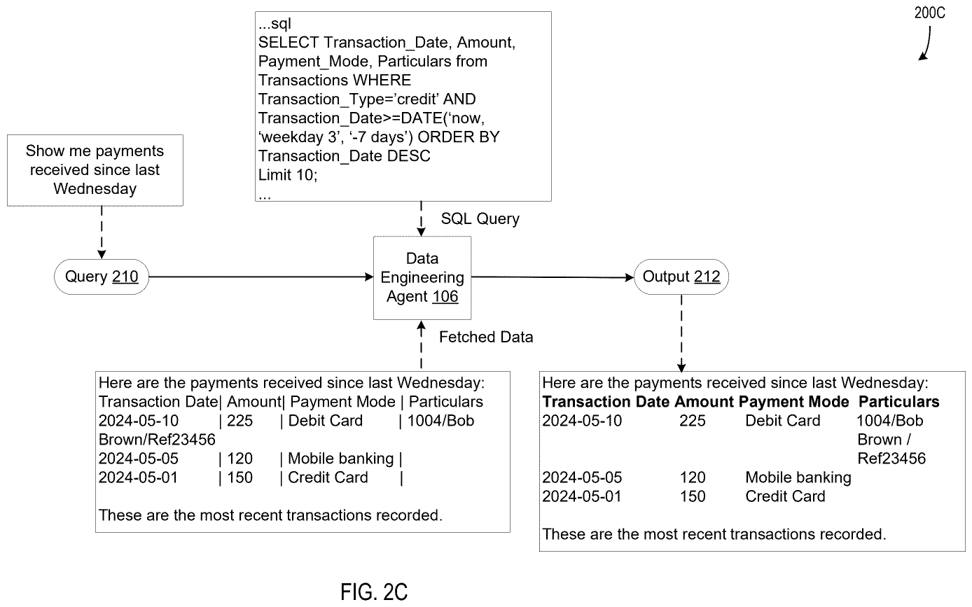

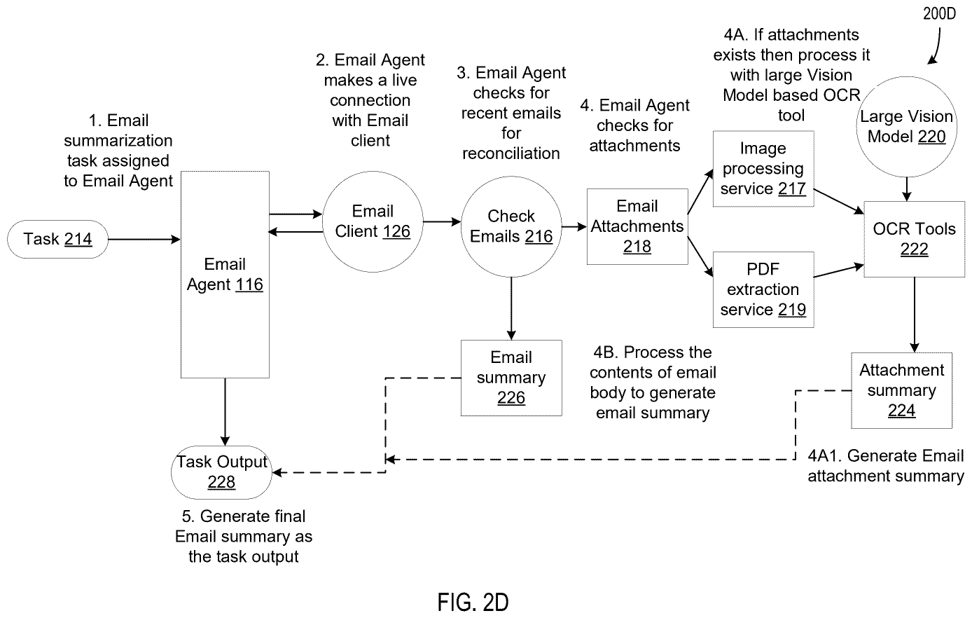

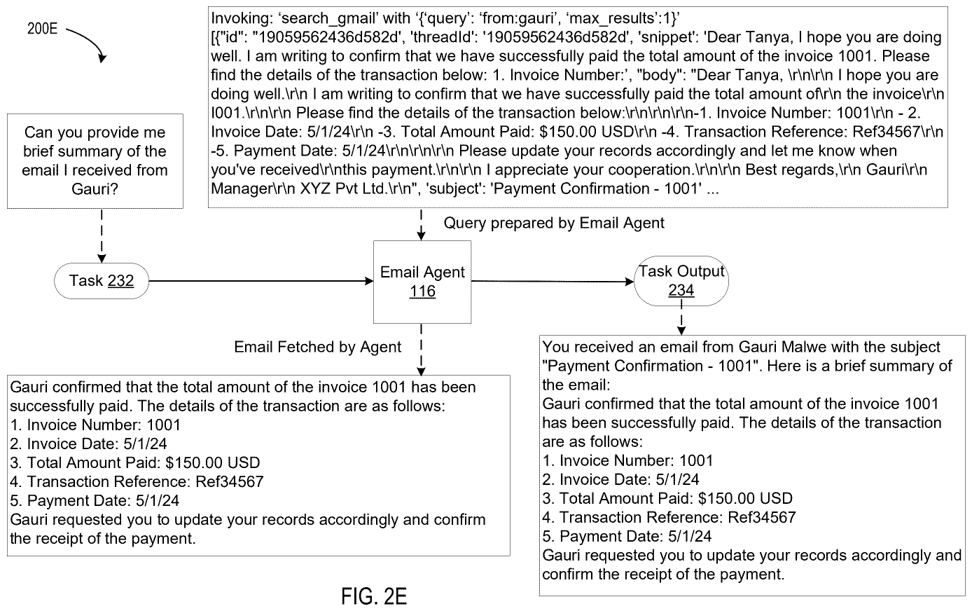

FIG. 2A illustrates a multi-agent architecture based invoice reconciliation workflow 200A where multiple agents are powered by LLMs and tools are integrated together using multi-agent framework. An invoice reconciliation job is triggered (e.g., based on receiving a request by a supervisor agent or at a predetermined time). Intent is extracted from the invoice reconciliation job and the intent is passed to the data engineering agent 106. The data engineering agent 106 requests to get invoice details from a database 114 (e.g., using a pre-existing SQL query or generating an SQL query for the invoice reconciliation job) based on the intent. Upon executing the SQL query details related to customer, invoice, and payment transaction are received by the data engineering agent 106. The data engineering agent 106 passes some of these details (e.g., email address of customer, invoice period etc.) to the email agent 116. The email agent checks emails from the email client 126 (e.g., emails associated with the customer details received from the data engineering agent) and receives summary of the email that includes summary of the content of the email and/or summary of the attachments. Outputs from the data engineering agent 106 and the email agent 116 are processed by the reconciliation agent 202 in a reconciliation process to generate a reconciled invoice record. The reconciled invoice record is used to update the invoice reconciliation details by the data engineering agent 106.

FIG. 2B illustrates data engineering agent architecture 200B used for invoice reconciliation. The data engineering agent architecture depicts a task 204 being assigned to the data engineering agent 106. For example, the task 204 is to perform natural language to SQL query generation. The data engineering agent 106 utilizes SQLite as an in-memory database to store business invoicing data, in some examples. As illustrated in FIG. 2B, this agent is a tool-calling agent that employs tools like an SQL query builder 108 and executor 110 to interact with the database 114. For example, the data engineering agent 106 uses query builder tool 108 to build query. The data engineering agent 106 performs query understanding and query validation of the query built by using the SQL query builder tool 108. Schema verification and query validation involves analyzing the proposed query against the database schema and validating its structural integrity and logical coherence.

Few SQL shot prompting techniques enhance its performance, providing schema information and sample queries to improve query accuracy. For example, the data engineering agent 106 uses the query executor tool 110 to execute the query with the help of few SQL shot prompts 206. These SQL shot prompts 206 provide detailed understanding of database structure and relationships, knowledge of column specifications and data types, sample query patterns for optimal execution strategies. Detailed schema information and exemplar queries, significantly improve the accuracy and reliability of database interactions. The data engineering agent 106 then performs SQL query output using natural language translation to produce the final output 208 of the task. For example, the data engineering agent 106 transforms the SQL query results into clear, natural language responses. This translation ensures that technical database outputs are converted into readily comprehensible information for end users.

FIG. 2C illustrates an example workflow 200C of the data engineering agent architecture as illustrated in FIG. 2B. For example, for the query 210 or the task of “Show me payments received since last Wednesday”, the data engineering agent 106 builds (using the SQL query builder tool 108) and then executes (using the SQL query executor tool 110) the SQL query to fetch data (e.g., data of the payments received since last Wednesday) and outputs (e.g., output 212) a summary of the fetched data (e.g., as first invoicing data).

FIG. 2D illustrates email agent architecture 200D used for invoice reconciliation. The email agent 116 receives a task 214 (e.g., an email summarization task assigned to the email agent for intent based on user query). For this task 214, the email agent 116 makes a live connection with email client 126 (e.g., to access an inbox of an email client such as Gmail, Outlook etc.) using an API to fetch and check emails 216 from supported email services. The email agent 116 via an API checks for and identifies recent and/or relevant emails from customers with an ‘Unpaid’ status for reconciliation. The email agent 116 then checks for email attachments 218 (e.g., using image processing service 217 and PDF extraction service 219). If an attachment exists, the email agent 116 processes it with a vision-model-based (e.g., a large vision model 220 based) optical character recognition (OCR) tool 222 to extract relevant invoice details from attachments and generate an email attachment summary 224. The email agent 116 processes the content of email body to generate the email summary 226. In some examples, if no attachments exist, the email agent 116 processes the email body content directly to extract and summarize invoice details. The email summary 226 and/or the attachment summary 224 is used to generate the final email summary as task output 228 of the email agent 116.

FIG. 2E illustrates an example workflow 200E of the email agent architecture as illustrated in FIG. 2D. For example, for the task 232 “Can you provide me brief summary of the email I received from Gauri?”, the email agent 116 prepares or generates a query that is executed (e.g., on the Inbox of the email client) to fetch email (e.g., related to the invoice number 1001) by the email agent 116. The email agent 116 summarizes the fetched email to generate a task output 234.

In some examples, output from the data engineering agent 106 and output from the email agent 116 are reconciled (e.g., by a reconciliation agent) to generate a reconciliation report 112 as illustrated in FIG. 1. Examples of the disclosure may reconcile data from more than two agents without deviating from aspects of the invention.

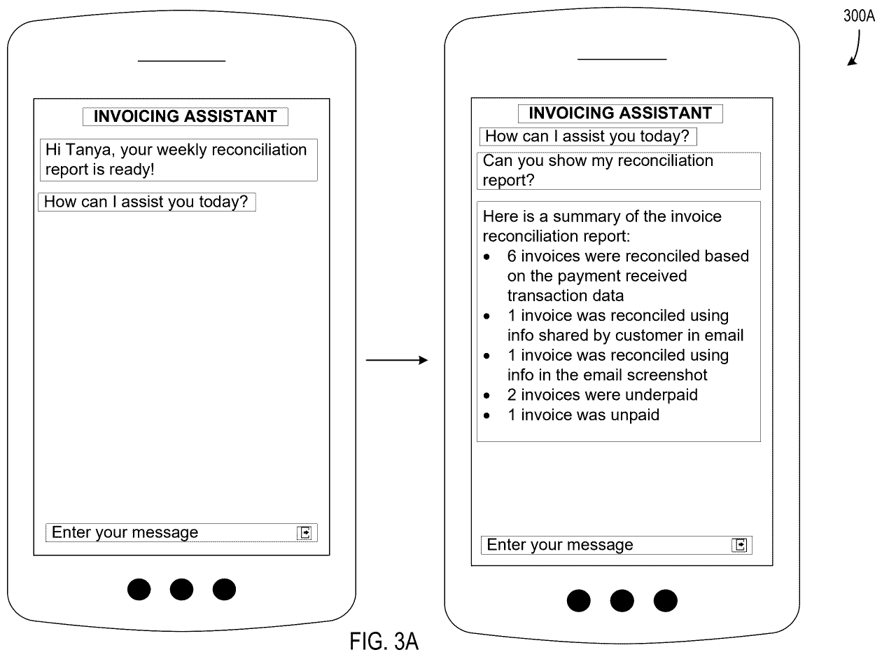

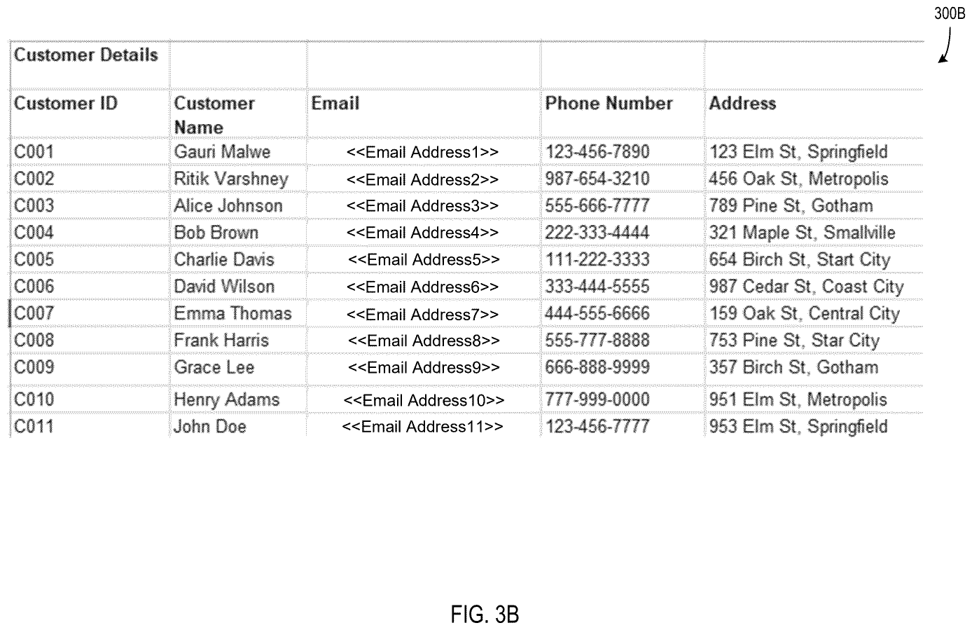

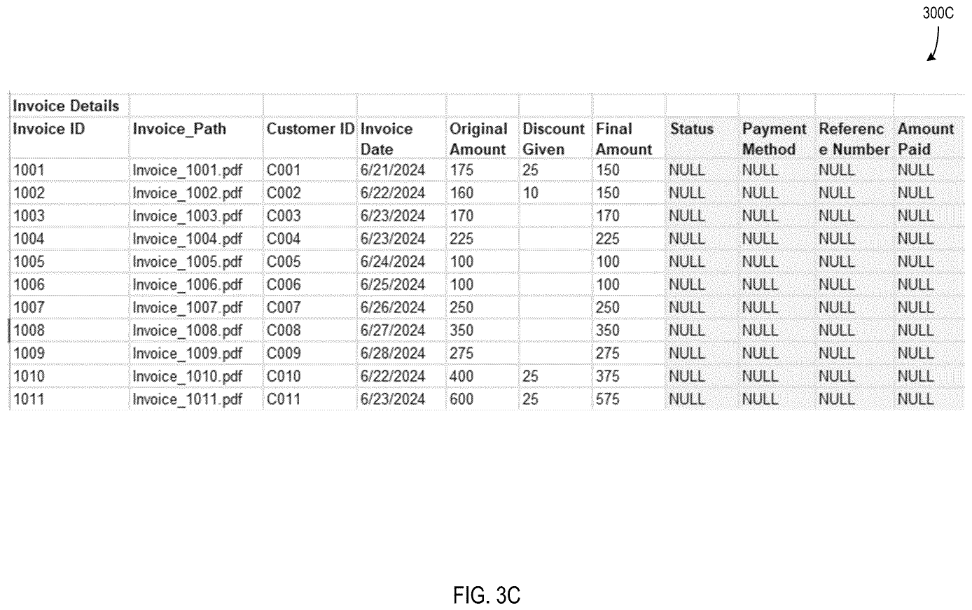

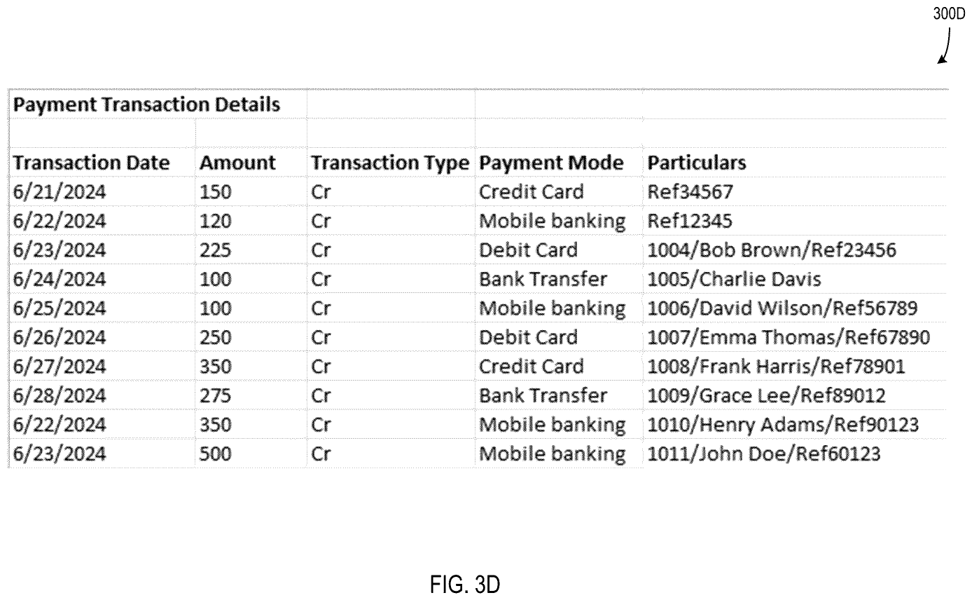

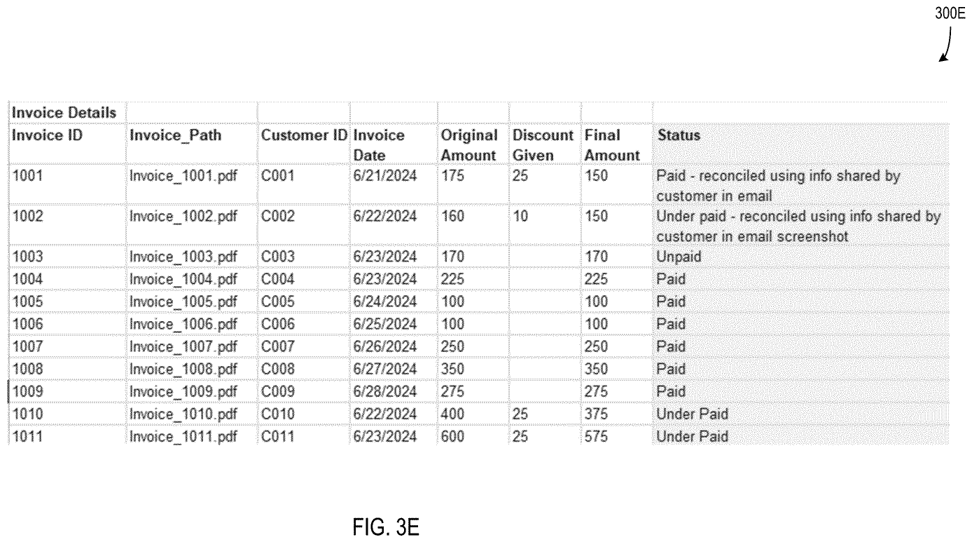

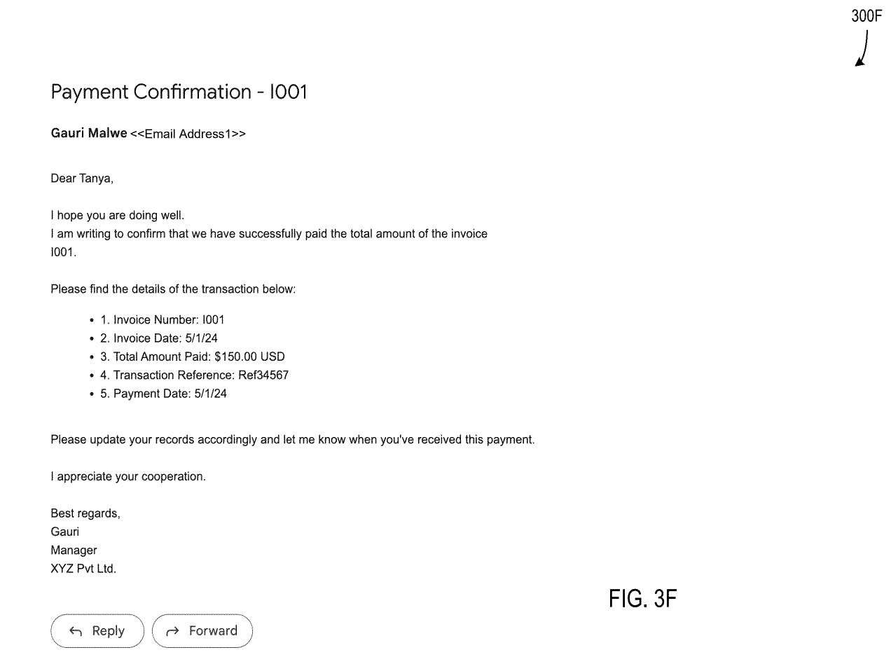

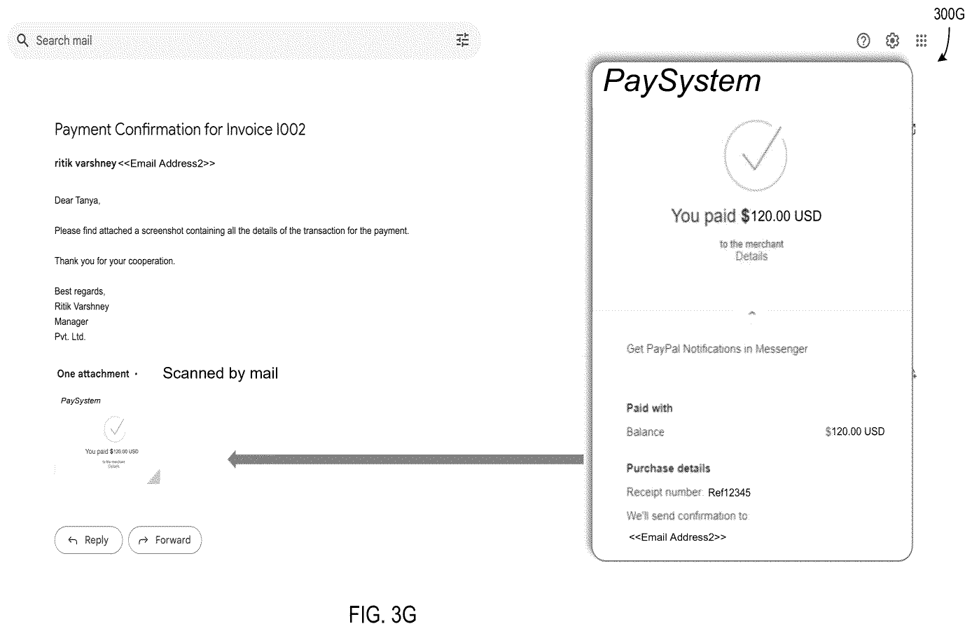

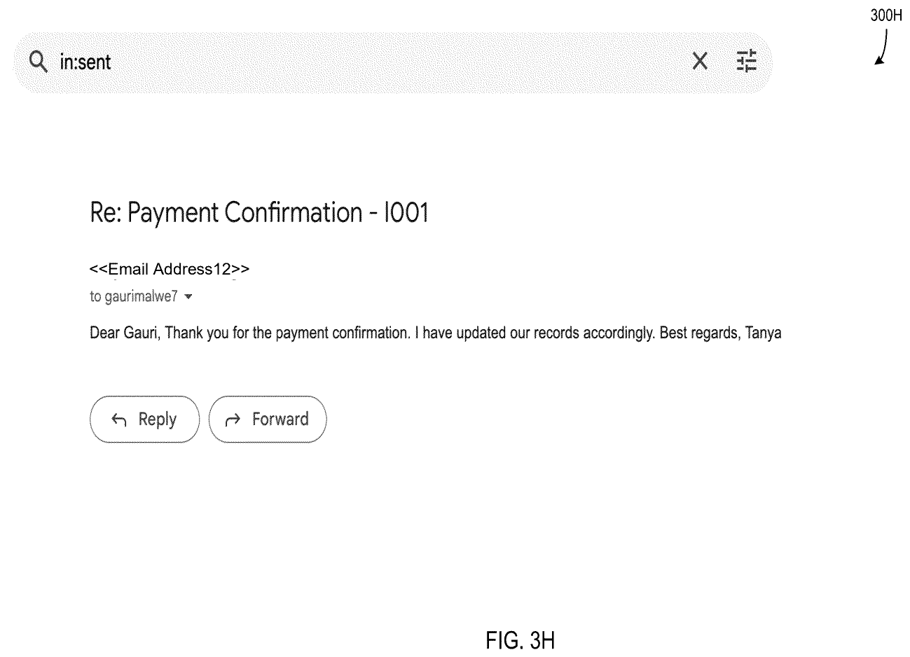

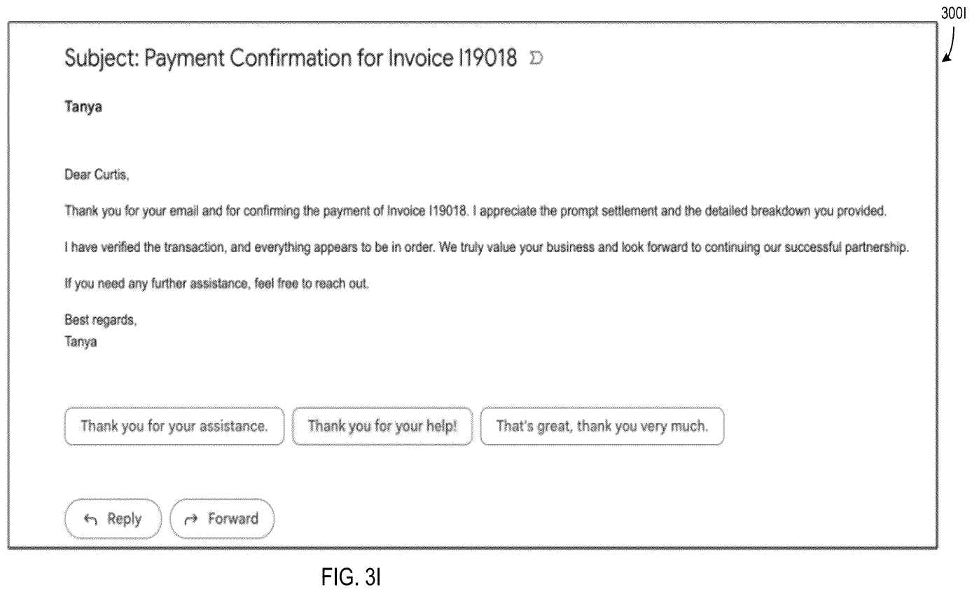

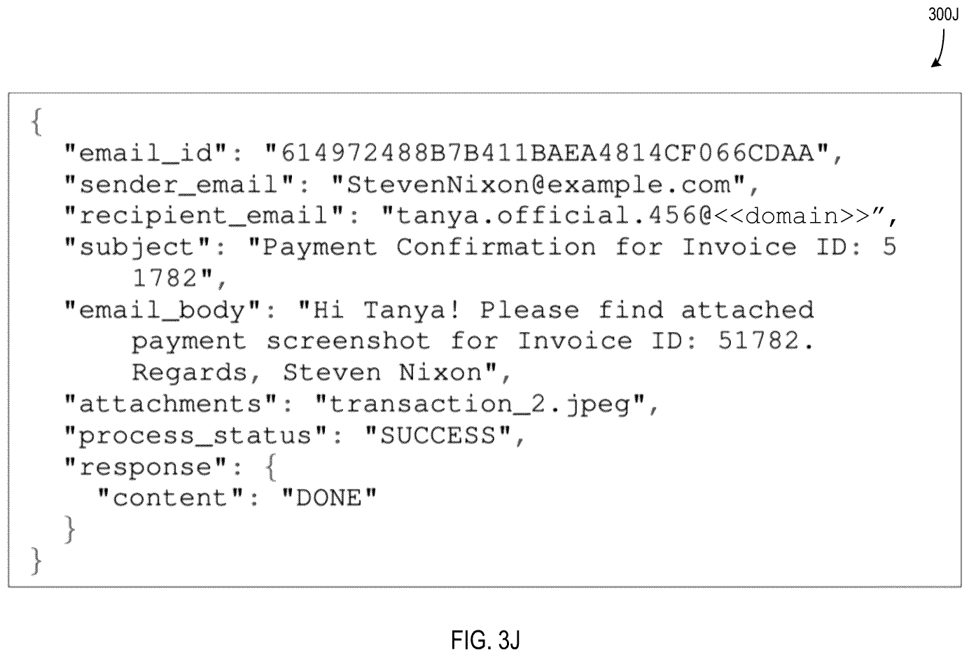

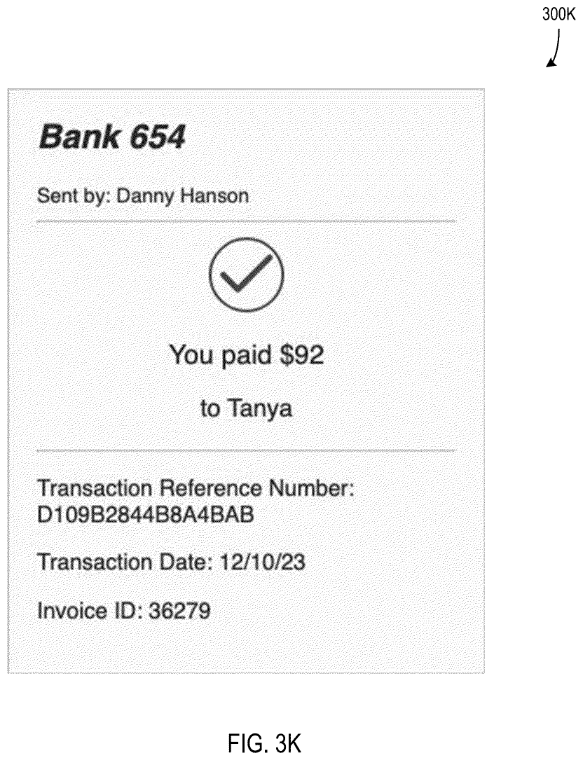

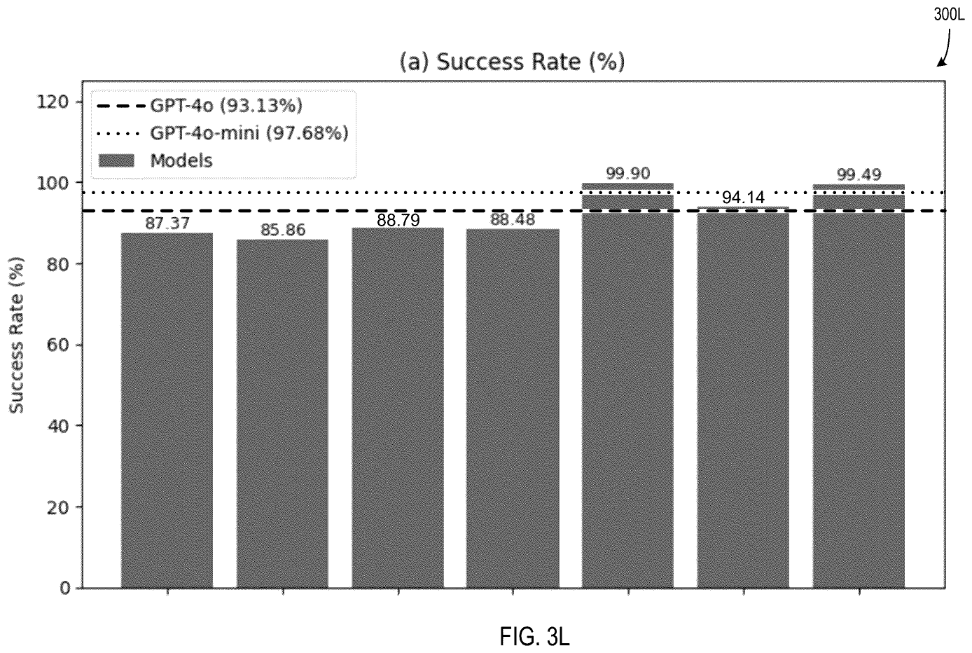

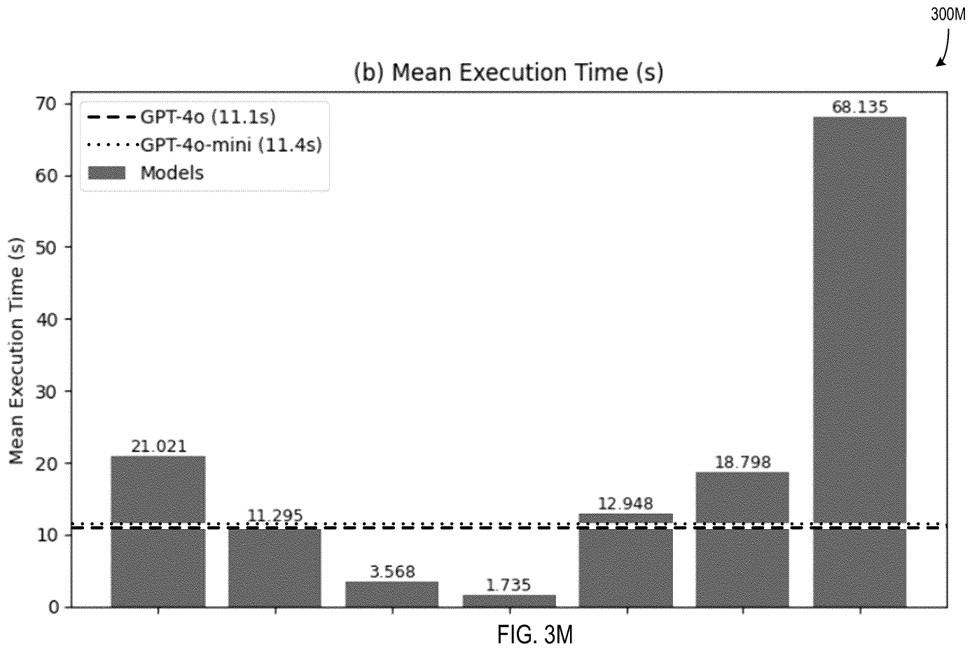

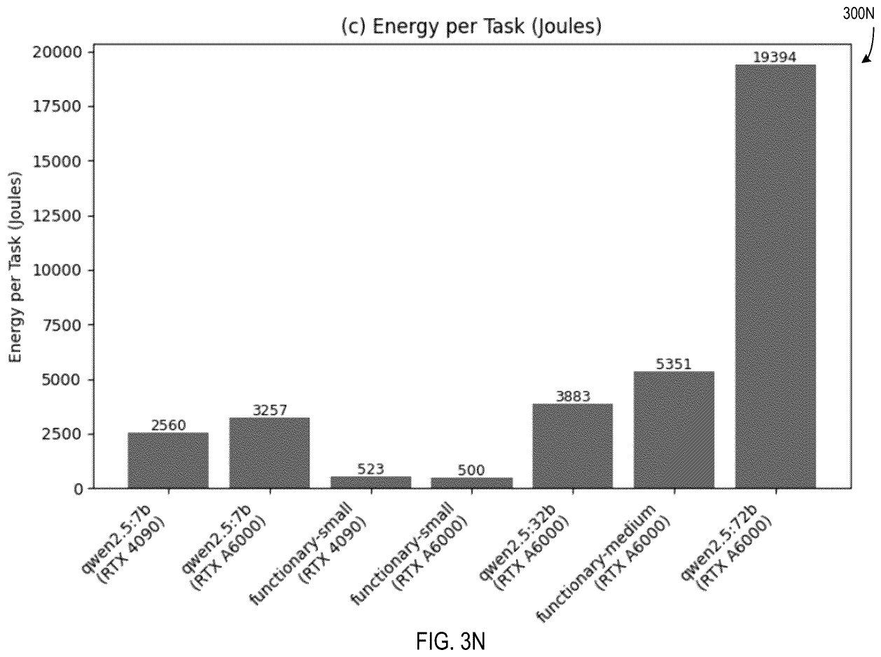

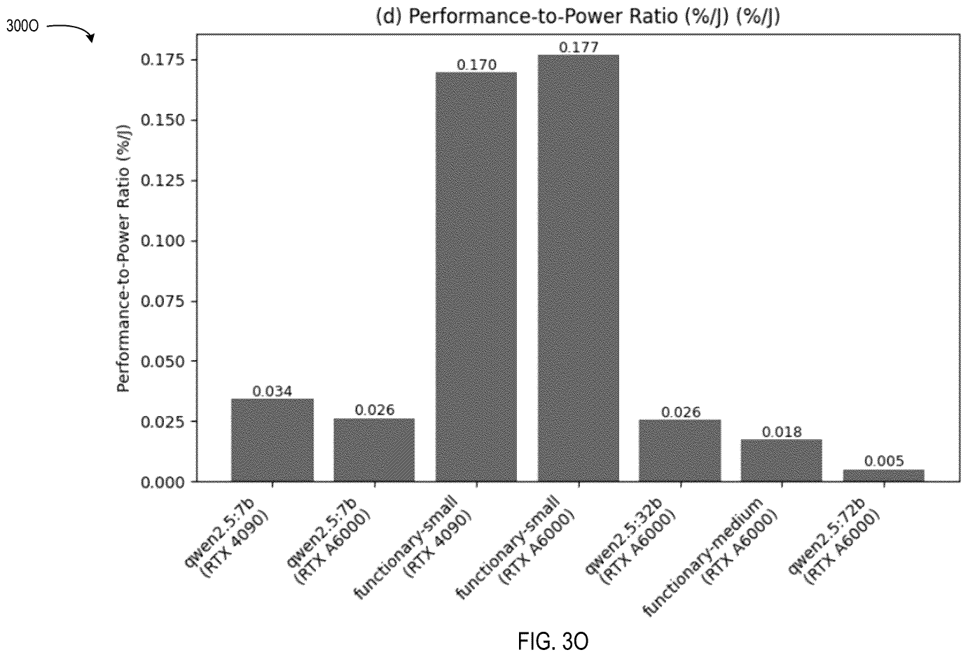

FIG. 3A is an example workflow 300A of an invoicing assistant for invoice reconciliation. The invoicing assistant is a customized virtual assistant trained to facilitate invoice reconciliation. For example, when the invoicing assistant is invoked by a user, it greets the user with a status such as “your weekly reconciliation report is ready” and “How can I assist you today?” (e.g., as shown in snapshot on left side of FIG. 3A). If the user enters a message such as “Can you show my reconciliation report?”, the invoicing assistant provides a summary of the invoice reconciliation report (e.g., as shown in snapshot on right side of FIG. 3A). In an example, the user may further interact with the invoicing assistant to see further details on any of the pointers in the summary of the reconciliation report, e.g., the user may request to “provide details of the invoice reconciled using info shared by customer in email” and the invoicing assistant will provide the requested detail (not shown). In another example, the user may instruct the invoicing assistant to draft an email response for another user requesting confirmation about an invoice. In this example, the invoicing assistant performs invoice reconciliation, drafts a response message, and automatically (or after confirmation from the user) sends the response message.

FIG. 3B is an exemplary customer details schema 300B. In this example, the customer details schema 300B includes a customer ID, customer name, Email address, phone number, and an address of the customers. The customer details schema 300B may include fewer details or more details (e.g., an instant messaging ID) without deviating from aspects of the invention.

FIG. 3C is an exemplary invoice details schema 300C before invoice reconciliation. In this example, invoice details schema 300C includes invoice ID, invoice path, customer ID, invoice date, original amount, discount given, final amount, status, payment method, reference number, and amount paid. It may be noted that the fields status, payment method, reference number, and amount paid have value “NULL” before invoice reconciliation. The invoice details schema 300C may include fewer details or more details without deviating from aspects of the invention.

FIG. 3D is an exemplary payment transaction details schema 300D. In this example, the payment transaction details schema 300D includes transaction date, amount, transaction type, payment mode, and particulars of the payment transactions. The payment transaction details schema 300D may include fewer details or more details without deviating from aspects of the invention.

FIG. 3E is an exemplary invoice details schema 300E post invoice reconciliation. In this example, the invoice details schema 300E includes invoice ID, invoice path, customer ID, invoice date, original amount, discount given, final amount, status, payment method, reference number, and amount paid (e.g., as in FIG. 3C before invoice reconciliation). It may be noted that in this invoice details schema 300E, the “Status” field is reconciled from the payment transaction details schema 300D. In the invoice details schema 300E post invoice reconciliation, the fields of payment method, reference number, and amount paid are not shown in FIG. 3E for ease of illustration.

FIG. 3F is an example screenshot 300F of an email requesting payment confirmation for an invoice with invoice details in content of the email message.

FIG. 3G is an example screenshot 300G of an email requesting payment confirmation for an invoice with invoice details in an attachment of the email. In some examples, a user triggers invoice reconciliation e.g., via a virtual assistant, upon receipt of such email. In some other examples, the email agent periodically (e.g., every 5 minutes, every hour, etc.) scans inbox of the email client for any email message requesting payment confirmation for an invoice and automatically triggers the invoice reconciliation process if any such email message is found in the inbox.

FIG. 3H is an example screenshot 300H of an automated email response for the request in FIG. 3F. In some examples, the email response in FIG. 3H is automatically sent as per the user request shown in FIG. 3F. In some other examples, the email response (e.g., such as in FIG. 3H) is generated and shown to the user for review and update (if required) before sending (e.g., by clicking on “Send” button).

FIG. 3I is an example screenshot 300I of an automated email response for another example request for confirmation of payment.

FIG. 3J is an example of email data 300J used by the email agent. For example, the email data 300J includes email_id, sender_email, recipient_email, subject, email_body, attachments, process_status, response, and content etc.

FIG. 3K is an example screenshot 300K of an email attachment processed by the email agent.

FIG. 3L to 3O illustrate evaluation metrics across models and hardware platforms. FIG. 3L illustrates evaluation results 300L for success rate (%), indicating the percentage of tasks successfully completed by each model. FIG. 3M illustrates evaluation results 300M for Mean Execution Time (s), reflecting the average processing time per task. FIG. 3N illustrates evaluation results 300N for Energy per Task (Joules), showing the total energy consumption for processing a single task. FIG. 3O illustrates evaluation results 300O for Performance-to-Power Ratio (%/J), a measure of model efficiency in terms of task success relative to energy consumption. Horizontal dashed lines in FIG. 3L and FIG. 3M represent reference benchmarks: GPT-4o and GPT-4o-mini, which achieved task success rates of 93.13% and 97.68%, with mean execution times of 11.1 s and 11.4 s, respectively. The results highlight trade-offs between accuracy, execution time, and energy efficiency for various models.

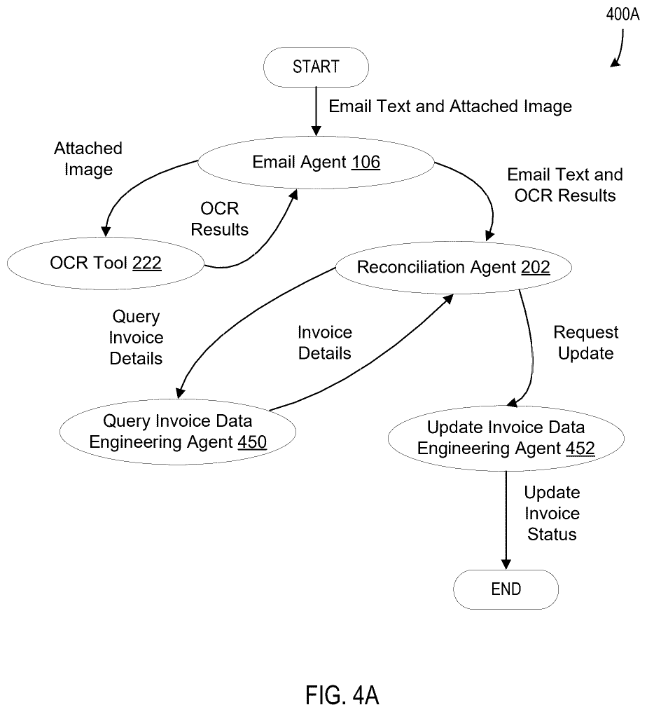

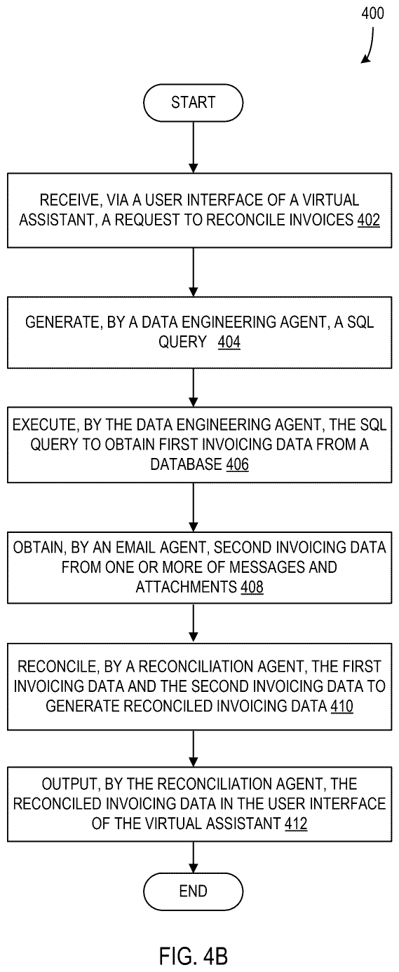

FIG. 4A is an exemplary LangGraph-based agentic workflow 400A for invoice reconciliation. In this example, the process begins with the initialization of the workflow by the Email Agent 116, which processes incoming emails containing both text and attached images. If an image is attached, the OCR Tool 222 extracts relevant structured data from the image. The extracted data, along with the email text, is then forwarded to the Reconciliation Agent 202 for further analysis. The Reconciliation Agent 202 acts as the central hub of the workflow, coordinating interactions between various agents. When necessary, it queries the Invoice Data Engineering Agent 450 for additional invoice details. If the reconciliation process determines that updates are required, the Reconciliation Agent 202 communicates with the Update Invoice Data Engineering Agent 452 to update the invoice status in the database. The graph-based structure, powered by LangGraph, ensures flexibility in handling diverse scenarios while optimizing efficiency and maintaining adaptability for edge cases. The modular design enables seamless collaboration among agents and effectively supports complex invoice reconciliation tasks.

FIG. 4B is a flowchart illustrating an example method 400 for invoice reconciliation using a multi-agent system. At 402, a request to reconcile one or more invoices is received via a user interface of a virtual assistant. At 404, an SQL query is generated by a data engineering agent. At 406, the SQL query is executed to obtain first invoicing data from a database by the data engineering agent. At 408, an email agent obtains second invoicing data from one or more of messages and attachments. At 410, a reconciliation agent reconciles the first invoicing data and the second invoicing data to generate reconciled invoicing data. At 412, the reconciled invoicing data is outputted in the user interface of the virtual assistant by the reconciliation agent.

Examples of the disclosure operate in an unconventional and advantageous manner by reconciling invoicing data using multiple agents in a multi-agent framework. Further, examples of the disclosure utilize edge LLMs that are designed to run on edge devices, such as smartphones, IoT devices, and embedded systems, instead of relying on cloud-based infrastructure. By running locally on edge devices, these models provide lower latency, better privacy, and reduced dependence on constant internet connectivity.

Examples of the disclosure improve on traditional machine learning (ML) models when handling real-world invoicing data, particularly in cases of skewed distribution patterns. The LLM-agent based system addresses limitations of the traditional systems through improved context understanding and AI-powered adaptive processing capabilities that create a flexible and adaptable agent-based workflow to accommodate various business requirements. Examples of the disclosure maintain regulatory compliance requirements while leveraging advanced AI capabilities. Multi-agent collaboration enhances processing capabilities of the system to provide comprehensive recognition of invoice data in text messages and attachments (including image, PDF, voice, etc.) to accurately reconcile invoices in an automated manner. An efficient workflow is created for invoice reconciliation that maintains clear communication channels between agents while optimizing for resource constraints.

In some examples, the invoice reconciliation service operates as a batch job (e.g., a batch reconciliation service), reconciling emails and database records on a periodic basis (e.g., daily, weekly, or monthly). The reconciliation service may be configured as a nightly job, performing automated reconciliation for each day. The invoice reconciliation service consists of three primary agents: the data engineering agent, the reconciliation agent, and the email agent, as illustrated in FIG. 2A. These agents follow a sequential communication pattern, as the reconciliation flow is fixed for most applications. When the invoice reconciliation job is triggered, the data engineering agent initiates the process by identifying invoice data records with an ‘Unpaid’ status. It retrieves the names of customers with unpaid invoices and delegates tasks to the email agent.

The email agent performs the following tasks: (1) Email Context Understanding: Identifies emails containing invoicing details relevant to the reconciliation job, (2) Email Summarization: Summarizes invoicing details in the email body, and (3) Email Attachment Summarization: Extracts and summarizes invoicing details from attachments (e.g., images such as JPEG files representing payment screenshots) using OCR and large vision models.

Once the data is extracted, the reconciliation agent processes the combined information (e.g., email summary and email attachment summary). If the extracted data matches the invoice records in the database, the database is updated to mark the invoice as reconciled.

In some examples, the data engineering agent utilizes SQLite as an in-memory database to store business invoicing data. As illustrated in FIG. 2B, this agent is a tool-calling agent that employs tools like an SQL query builder and executor to interact with the database. Few-shot prompting techniques enhance its performance, providing schema information and sample queries to improve query accuracy.

In some examples, the email agent accesses the client email inbox using an API, searches for relevant emails, and processes attachments. For example, Gmail may be used as the email client, though other clients can be substituted. The agent uses a vision-model-based OCR tool to extract text from attachments and processes text in email bodies for summarization. The attachments may be image, PDF, and/or any other format (e.g., DOCX).

In some examples, a real-time chat assistant (e.g., a virtual assistant) extends the functionality of the batch reconciliation service by enabling interactive communication between end users and the system. Users can query the assistant for insights such as “Show me my weekly or monthly reconciliation summary” to obtain actionable business intelligence. As illustrated in FIG. 1, the chat assistant workflow incorporates specialized agents such as: (1) supervisor agent: Manages conversational interactions, interprets user intent, and delegates tasks to the appropriate agent, (2) data engineering agent: Responds to queries regarding reconciliation jobs, customer records, and invoice data (FIG. 2C), and (3) Email Agent: Handles queries related to emails and email attachments in real time (FIG. 2E). A noteworthy feature of the chat assistant is its ability to send acknowledgment emails after invoices are successfully reconciled (e.g., as illustrated in FIGS. 3H and 3I).

Examples of the disclosure leverage a graph-based architecture to enable flexible and dynamic workflows. By supporting dynamic execution paths, it facilitates modular and adaptive task pipelines, making it highly suitable for complex applications that require customizable and context aware processing.

In an example implementation, a custom experimental synthetic data generation script written in Python is utilized to generate a dataset of 990 invoice payment confirmation emails with attachments, where the task involved extracting invoicing information from the attached images. Each entry in the dataset is carefully designed to include all the necessary details required for successful invoice reconciliation. This ensures that the evaluation focused exclusively on the agent's performance in processing and extracting information, without introducing limitations or biases stemming from the dataset. All emails and images are systematically generated by the script, stored locally, and preprocessed into JSON and JPEG formats to enable efficient batch processing during experimentation.

In an example implementation, the system employs the following LLMs for comparative evaluation: (1) Proprietary Models (such as OpenAI gpt-4o and gpt-4o-mini), and (2) Open-Source Models (such as Functionary V3.1 (8B and 70B parameter variants), Qwen2.5 (7B, 32B, and 72B parameter variants), and Llama3.2-Vision-11B). For benchmarking purposes, OpenAI models (gpt-4o and gpt-4o-mini) are included as reference baselines. Unlike gpt-4o and gpt-4o-mini, the selected opensource models, Functionary V3.1 and Qwen2.5, excel in function calling but lack the vision capabilities required for OCR of attached images. To address this limitation, these models are implemented with Llama3.2-Vision-11B, which provides robust vision-based functionality for tasks involving image processing.

All open-source models are executed locally using Ollama, which provides a unified interface for inference and evaluation. The Qwen2.5 models are referred to as qwen2.5:7b, qwen2.5:32b, and qwen2.5:72b, while Llama3.2-Vision-11B is referred to as llama3.2-vision:1 Ib, following the naming conventions provided on the Ollama website. Since official Functionary models are not available on Ollama, two models are implemented locally using GGUF files (which is a file format used for storing models for inference, especially in the context of language models like GPT) sourced from Hugging Face. These models are referred to as functionary-small and functionary-medium.

To evaluate the effectiveness of the agents, the AI agents sequentially process all 2,000 entries in the evaluation dataset. The result for each entry is stored in a SQLite3 database, with records mapped one-to-one to the evaluation dataset. Additionally, running logs are saved as text files to facilitate detailed data analysis. To assess the performance and efficiency of various models, the following metrics are employed: (1) Success Rate, (2) Mean Execution Time (MET), (3) Energy per Task, and (4) Performance-to-Power Ratio.

The Success Rate metric measures the effectiveness of an agent in completing tasks and achieving its objectives. A task is considered successful if the process_state field in the database table is marked as SUCCESS. The Success Rate is calculated as:

$$Success Rate = \frac{Number of Successful Tasks}{Size of Evaluation Dataset}$$

The MET metric represents the average time (in seconds) required for an agent to process a task. It is calculated as:

$$Mean Execution Time ( s ) = \frac{Total Evaluation Time ( s )}{Size of Evaluation Dataset}$$

The Energy per Task metric quantifies the energy required to process a task, measured in Joules (J). It is calculated as:

$$Energy per Task ( J ) = MRT ( s ) \times {P}_{CPU + GPU} W$$

Where P_{CPU+GPU} represents the average power consumption of the CPU and GPU during task execution, excluding idle power.

The Performance-to-Power Ratio metric evaluates the efficiency of an agent's performance relative to its energy consumption. It is defined as:

$$Performance - to - Power Ratio ( \% / J ) = \frac{Success Rate ( \% )}{Energy per Task ( J )}$$

These metrics offer a comprehensive evaluation of both predictive performance and computational efficiency. The Success Rate measures the agent's overall effectiveness in task processing, while the Mean Response Time underscores the practical feasibility of the system across different hardware configurations. Additionally, energy-based metrics highlight the sustainability and energy efficiency of various deployment strategies.

In some examples, the system is implemented using the agentic framework (e.g., LangGraph), which employs a graph-based architecture to enable flexible and dynamic workflows. This framework supports dynamic execution paths, facilitating modular and adaptive task pipelines. As a result, it is particularly well suited for complex applications requiring customizable and context-aware processing.

In some examples, Performance testing of the selected Ollama models was conducted across two distinct hardware systems, representing typical edge environments suitable for average users in SMEs:

Windows Desktop with NVIDIA RTX A6000 Ada Generation GPU: This system, running Ubuntu 22.04 via Windows Subsystem for Linux (WSL), is equipped with 48 GB of VRAM and costs around $10,000 USD. This configuration is referred to as RTX A6000.

Windows Laptop with NVIDIA GeForce RTX 4090 Laptop GPU: Operating on Ubuntu 24.04 via WSL, this high-performance laptop features 16 GB of VRAM and costs around $5,000 USD. This configuration is referred to as RTX 4090.

Due to memory constraints, only smaller models—namely qwen2.5-7b, functionary-small, and llama3.2-vision:11b—were evaluated on the RTX 4090. In contrast, all open-source models were tested on the RTX A6000, which offers greater memory capacity.

The experimental results, presented in FIG. 3L to FIG. 3O, reveal significant performance variations across different model configurations and hardware platforms. These results are analyzed across four key metrics.

Success Rate: The proprietary models establish robust benchmarks for task success. GPT-4o and GPT-4o-mini achieved success rates of 93.13% and 97.68%, respectively. Among edge-deployed models: (1) qwen2.5-32b achieved the highest success rate (99.9%), followed closely by qwen2.5-72b at 99.49%. Both surpassed the success rates of the proprietary OpenAI models. (2) Functionary-medium achieved a 94.14% success rate, surpassing GPT-4o but falling short of GPT-4o-mini. (3) Smaller models such as functionary-small and qwen2.5-7b exhibited lower success rates (around 88.48% and 87.37%, respectively), though their results were consistent across platforms. (4) The superior performance of qwen2.5-32b and GPT-4o-mini demonstrates that larger models do not necessarily outperform smaller or mid-tier models, emphasizing the importance of thorough evaluation and selecting the right model tailored to the specific task requirements.

Mean Execution Time: Execution times varied significantly across models: (1) GPT-4o and GPT-4o-mini set the baseline with execution times of 11.1 s and 11.4 s, respectively. (2) The fastest execution time (1.735 s) was achieved by functionary-small on the RTX A6000, while qwen2.5-72b required the longest time (68.135 s), highlighting a trade-off between task success and efficiency. (3) The execution time of qwen2.5-32b is comparable to OpenAI models, making it a superior candidate for this task due to its top performance and reasonable speed.

Energy Efficiency: Energy consumption trends exhibited notable variations: (1) Smaller models, such as functionary-small, consumed as little as 523 J per task on the RTX 4090, whereas larger models, like qwen2.5-72b, consumed up to 19,394 J on the RTX A6000. (2) The results indicate a substantial increase in energy requirements for high-performing, large-scale models, particularly for qwen2.5-72b. This is likely due to the longer execution time, as the model cannot be fully loaded into the 48 GB VRAM of the GPU, leading to performance bottlenecks.

Performance-to-Power Ratio: The performance-to-power ratio provided valuable insights into the efficiency of the models: (1) The highest efficiency was achieved by functionary-small, with a ratio of 0.177%/J on the RTX A6000 and 0.17%/J on the RTX 4090. (2) Conversely, the largest model, qwen2.5-72b, exhibited the lowest efficiency, achieving only 0.005%/J on the RTX A6000. This underscores the substantial energy cost associated with running larger models.

These results highlight the trade-offs between deploying large models and smaller, more energy-efficient alternatives. Edge environments can particularly benefit from mid-tier models like functionary-small, which strike a balance between success rate and resource consumption, making them ideal for practical use cases such as real-time invoice reconciliation. From a cost perspective, functionary-small performs efficiently on the RTX 4090, a gaming laptop priced around $5,000 USD, which is approximately half the cost of the RTX A6000, a high-end desktop priced around $10,000 USD. This cost efficiency makes functionary-small a suitable choice for deployment in SMEs with limited budgets.

A detailed analysis conducted on the Agentic Workflow for Invoice Reconciliation highlights an uneven distribution of responses across different configurations of Edge-based Large Language Models (LLMs). The outputs of the Agentic Workflow were categorized into three distinct groups. (1) Success, (2) No invoice, and (3) Error.

SUCCESS: This category represents cases where the Agentic Workflow successfully located, identified, and loaded the invoice data into the system. In these scenarios, the workflow performed as expected, handling data extraction and reconciliation seamlessly. A sample JSON output for a successful instance of the Agentic Workflow is illustrated below:

{
“email_id”: “614972488B7B411BAEA4814CF066CDAA”,
“sender_email”: “StevenNixon@example.com”,
“recipient_email”: “tanya.official.456@<<domain>>”,
“subject”: “Payment Confirmation for Invoice ID: 51782”,
“email_body”: “Hi Tanya! Please find attached payment screenshot for Invoice ID: 51782.
Regards, Steven Nixon”,
“attachments”: “transaction_2.jpeg”,
“process_status”: “SUCCESS”,
“response”: {
“content”: “DONE”
}
}

NO INVOICE: This status indicates failure by the Agentic Workflow due to one of the following reasons: (1) OCR Task Failure: The agent was unable to complete the OCR process due to LLM hallucinations. This occurs when the model generates and extracts information that does not exist in the source image, deviating from the ground truth. (2) Reconciliation Task Failure: The agent failed to perform reconciliation due to LLM hallucinations, where the LLM misinterpreted the natural language queries and generated invalid structured SQL queries.

A JSON output example illustrating a NO_INVOICE case caused by OCR task hallucinations is provided below:

{
“email_id”: “75C1B5DF284745D8981B33F181DB548D”,
“sender_email”: “RyanNelson@example.com”,
“recipient_email”: “tanya.official.456@<<domain>>”,
“subject”: “Payment Confirmation for Invoice ID: 41539”,
“email_body”: “Hi Tanya! Please find attached payment screenshot for Invoice ID: 41539.
Regards, Ryan Nelson”,
“attachments”: “transaction_46.jpeg”,
“process_status”: “NO_INVOICE”,
“response”: “I'm sorry, but it seems there has been a misunderstanding. The provided text
does not contain any information related to invoices or a payment confirmation. Therefore,
I will respond with \“NA\” and the reason.\n\ nResponse: NA - No invoice data found in the
provided text.\n\nIf you have an email with invoice details, please provide that for
reconciliation.”
}

ERROR: This status denotes instances where the Agentic Workflow failed to perform or complete the task due to LLM hallucinations. In such cases, the LLM fundamentally misunderstood the context, leading to a complete misinterpretation of the workflow requirements. A sample JSON output demonstrating an ERROR case, where the LLM misinterpreted the context, is shown below:

{
“email_id”: “3E749031E0024D64B0A701D5F7552B99”,
“sender_email”: “AmandaLuna@example.com”,
“recipient_email”: “tanya.official.456@<<domain>>”,
“subject”: “Payment Confirmation for Invoice ID: 93410”,
“email_body”: “Hi Tanya! Please find attached payment screenshot for Invoice ID:
93410. Regards, Amanda Luna”,
“attachments”: “transaction_250.jpeg”,
“process_status”: “ERROR”,
“response”: “I'm sorry, but it seems there is an inconsistency with the OCR results
and the email content. The invoice ID provided does not match any records in our
database. Can you please provide more information or verify the details?\n\nFor
now, I will prefix this response with \“ERROR\” and the reason for the
discrepancy.\n\nPlease let me know how to proceed next.”
}

To better understand the distribution of SUCCESS, NO_INVOICE, and ERROR responses across models and platforms, Table I provides a summary of the performance metrics:

TABLE I
SUCCESS AND ERROR METRICS
ACROSS MODELS AND PLATFORMS

| Model | Platform | SUCCESS | NO_INVOICE | ERROR |
|---|---|---|---|---|
| qwen2.5:7b | RTX 4090 | 865 | 2 | 123 |
| qwen2.5:7b | RTX A6000 | 850 | 4 | 136 |
| functionary- | RTX 4090 | 879 | 101 | 10 |
| small | | | | |
| functionary- | RTX A6000 | 876 | 108 | 6 |
| small | | | | |
| qwen2.5:32b | RTX A6000 | 989 | 0 | 1 |
| functionary- | RTX A6000 | 932 | 47 | 11 |
| medium | | | | |
| qwen2.5:72b | RTX A6000 | 985 | 1 | 4 |

The results highlight several notable trends: (1) Platform Variations: Performance differences were observed across platforms. The RTX 4090 achieved higher success rates for the qwen2.5:7b and functionary-small models compared to the RTX A6000, underscoring its suitability for edge applications that demand high throughput and efficiency. (2) Error Trends Across Model Families: The functionary-small and functionary-medium models recorded a higher number of NO_INVOICE cases, indicating potential limitations in handling certain data reconciliation scenarios. On the other hand, models from the qwen2.5 family exhibited a greater number of ERROR occurrences, suggesting challenges in interpreting task context accurately.

Thus, evaluation results using examples of the disclosure demonstrated the viability of mid-tier models like functionary-small, which strike an optimal balance between success rate and resource consumption, making them particularly suitable for real-time invoice reconciliation in edge environments. Additionally, the qwen2.5-32b model emerged as a superior alternative to proprietary solutions, achieving high success rates with comparable execution times. The system's architecture integrates localized LLM deployments with efficient agent coordination, offering scalability and adaptability to meet diverse business requirements. By employing advanced agentic frameworks, it enables modular and flexible workflows, ensuring practical applicability for SMEs.

In some examples, the reconciliation workflow utilizes a tool-based email agent (e.g., Lang Chain) to process emails and attachments received in a user's inbox. This agent extracts payment specific details from the emails and passes them to the data engineering agent. The data engineering agent utilizes the email extracted information along with bank payment transaction records and updates the reconciliation information against the respective invoice records in the database using a unique invoice reference number. The virtual assistant notifies the user in real-time as the reconciliation job is completed. The virtual assistant also enables the users to query specific information related to the reconciliation, database records, or emails received. The virtual assistant can also draft and send emails as per the user's instructions.

In some examples, agent execution is governed by a policy engine that dynamically selects which agents to invoke, skip, or re-run based on task complexity, historical performance metrics, or resource availability. For example, when a reconciliation task involves only structured data and no attachments, the email agent's attachment-processing subcomponents is bypassed to reduce computational overhead. Conversely, when ambiguity is detected in structured query results, additional verification agents may be invoked to validate invoice identifiers or transaction references.

In some examples, the reconciliation agent computes a confidence score associated with reconciled invoicing data. The confidence score is derived from one or more factors including consistency between structured and unstructured data, similarity scores between extracted invoice identifiers, temporal alignment of payment dates, and validation against business rules (e.g., amount thresholds, currency consistency, etc.). The confidence score is stored in the database alongside the reconciled invoice record and used to drive downstream actions such as automated responses, human-in-the-loop review, or escalation workflows.

In some examples, AI and machine learning techniques are utilized to train the agents. The agents trained based on feedback on their actions related to the historical invoice reconciliation requests by applying an unsupervised machine learning algorithm. For example, the unsupervised machine learning algorithm is a Long Short-Term Memory (LSTM) network. In some examples, the machine learning algorithm includes supervised and/or unsupervised techniques, such as those involving artificial neural networks, association rule learning, recurrent neural networks (RNN), Bayesian networks, clustering, deep learning, decision trees, genetic algorithms, Hidden Markov Modeling (HMM), inductive logic programming, learning automata, learning classifier systems, logistic regressions, linear classifiers, quadratic classifiers, reinforcement learning, representation learning, rule-based machine learning, similarity and metric learning, sparse dictionary learning, support vector machines, and/or the like.

### Exemplary Operating Environment

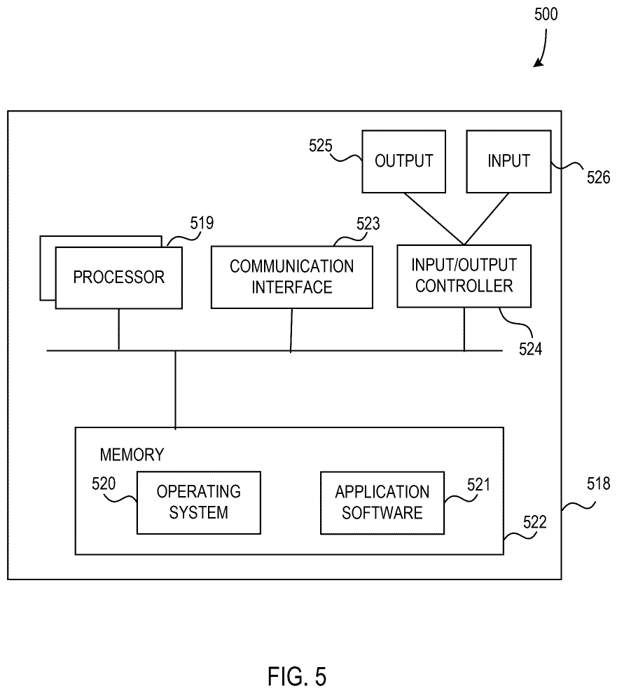

The present disclosure is operable with a computing apparatus according to an embodiment as a functional block diagram 500 in FIG. 5. In an example, components of a computing apparatus 518 are implemented as a part of an electronic device according to one or more embodiments described in this specification. The computing apparatus 518 comprises one or more processors 519 which may be microprocessors, controllers, or any other suitable type of processors for processing computer executable instructions to control the operation of the electronic device. Alternatively, or in addition, the processor 519 is any technology capable of executing logic or instructions, such as a hard-coded machine. In some examples, platform software comprising an operating system 520 or any other suitable platform software is provided on the apparatus 518 to enable application software 521 to be executed on the device. In some examples, implementing automated invoice reconciliation using multiple agents is accomplished by software, hardware, and/or firmware.

In some examples, computer executable instructions are provided using any computer-readable media that is accessible by the computing apparatus 518. Computer-readable media include, for example, computer storage media such as a memory 522 and communications media. Computer storage media, such as a memory 522, include volatile and non-volatile, removable, and non-removable media implemented in any method or technology for storage of information such as computer readable instructions, data structures, program modules or the like. Computer storage media include, but are not limited to, Random Access Memory (RAM), Read-Only Memory (ROM), Erasable Programmable Read-Only Memory (EPROM), Electrically Erasable Programmable Read-Only Memory (EEPROM), persistent memory, phase change memory, flash memory or other memory technology, Compact Disk Read-Only Memory (CD-ROM), digital versatile disks (DVD) or other optical storage, magnetic cassettes, magnetic tape, magnetic disk storage, shingled disk storage or other magnetic storage devices, or any other non-transmission medium that can be used to store information for access by a computing apparatus. In contrast, communication media embody computer readable instructions, data structures, program modules, or the like in a modulated data signal, such as a carrier wave, or other transport mechanism. As defined herein, computer storage media does not include communication media. Therefore, a computer storage medium is not a propagating signal. Propagated signals are not examples of computer storage media. Although the computer storage medium (the memory 522) is shown within the computing apparatus 518, it will be appreciated by a person skilled in the art, that, in some examples, the storage is distributed or located remotely and accessed via a network or other communication link (e.g., using a communication interface 523).

Further, in some examples, the computing apparatus 518 comprises an input/output controller 524 configured to output information to one or more output devices 525, for example a display or a speaker, which are separate from or integral to the electronic device. Additionally, or alternatively, the input/output controller 524 is configured to receive and process an input from one or more input devices 526, for example, a keyboard, a microphone, or a touchpad. In one example, the output device 525 also acts as the input device. An example of such a device is a touch sensitive display. The input/output controller 524 may also output data to devices other than the output device, e.g., a locally connected printing device. In some examples, a user provides input to the input device(s) 526 and/or receives output from the output device(s) 525.

The functionality described herein can be performed, at least in part, by one or more hardware logic components. According to an embodiment, the computing apparatus 518 is configured by the program code when executed by the processor 519 to execute the embodiments of the operations and functionality described. Alternatively, or in addition, the functionality described herein can be performed, at least in part, by one or more hardware logic components. For example, and without limitation, illustrative types of hardware logic components that can be used include Field-programmable Gate Arrays (FPGAs), Application-specific Integrated Circuits (ASICs), Program-specific Standard Products (ASSPs), System-on-a-chip systems (SOCs), Complex Programmable Logic Devices (CPLDs), Graphics Processing Units (GPUs).

At least a portion of the functionality of the various elements in the figures may be performed by other elements in the figures, or an entity (e.g., processor, web service, server, application program, computing device, or the like) not shown in the figures.

Although described in connection with an exemplary computing system environment, examples of the disclosure are capable of implementation with numerous other general purpose or special purpose computing system environments, configurations, or devices.

Examples of well-known computing systems, environments, and/or configurations that are suitable for use with aspects of the disclosure include, but are not limited to, mobile or portable computing devices (e.g., smartphones), personal computers, server computers, hand-held (e.g., tablet) or laptop devices, multiprocessor systems, gaming consoles or controllers, microprocessor-based systems, set top boxes, programmable consumer electronics, mobile telephones, mobile computing and/or communication devices in wearable or accessory form factors (e.g., watches, glasses, headsets, or earphones), network PCs, minicomputers, mainframe computers, distributed computing environments that include any of the above systems or devices, and the like. In general, the disclosure is operable with any device with processing capability such that it can execute instructions such as those described herein. Such systems or devices accept input from the user in any way, including from input devices such as a keyboard or pointing device, via gesture input, proximity input (such as by hovering), and/or via voice input.

Examples of the disclosure may be described in the general context of computer-executable instructions, such as program modules, executed by one or more computers or other devices in software, firmware, hardware, or a combination thereof. The computer-executable instructions may be organized into one or more computer-executable components or modules. Generally, program modules include, but are not limited to, routines, programs, objects, components, and data structures that perform particular tasks or implement particular abstract data types. Aspects of the disclosure may be implemented with any number and organization of such components or modules. For example, aspects of the disclosure are not limited to the specific computer-executable instructions, or the specific components or modules illustrated in the figures and described herein. Other examples of the disclosure include different computer-executable instructions or components having more or less functionality than illustrated and described herein.

In examples involving a general-purpose computer, aspects of the disclosure transform the general-purpose computer into a special-purpose computing device when configured to execute the instructions described herein.

An example method performs invoice reconciliation. The computerized method comprises: receiving, via a user interface of a virtual assistant, a request to reconcile one or more invoices; generating, by a data engineering agent, a SQL query; executing, by the data engineering agent, the SQL query to obtain first invoicing data from a database; obtaining, by an email agent, second invoicing data from one or more of messages and attachments; reconciling, by a reconciliation agent, the first invoicing data and the second invoicing data to generate reconciled invoicing data; and outputting, by the reconciliation agent, the reconciled invoicing data in the user interface of the virtual assistant.

An example system for invoice reconciliation comprises: a processor; and a memory storing instructions that upon execution by the processor cause the processor to: trigger an invoice reconciliation service comprising a data engineering agent, an email agent, and a reconciliation agent; identify, by the data engineering agent, an invoice data record associated with an invoice with an unpaid status from a database; retrieve, by the data engineering agent, a name of customer from the identified invoice data record associated with the invoice with the unpaid status; identify, by the email agent, a message associated with the name of the customer; summarize, by the email agent, invoicing details from one or more of a body of the identified message and an attachment of the identified message; determine, by the reconciliation agent, that the summarized invoicing details correspond to the invoice with the unpaid status; and based on the determination, automatically update, by the reconciliation agent, the invoice data record in the database by changing the invoice as reconciled.

An example computer storage medium stores instructions that upon execution by a processor cause the processor to: analyze a message received in a messaging application; based on the analyzing, determine that the message is a request for confirming reconciliation of an invoice; execute, by a data engineering agent, a SQL query to obtain first invoicing data from a database for the request; obtain, by an email agent, second invoicing data from the message; reconciling, by a reconciliation agent, the first invoicing data and the second invoicing data to generate reconciled invoicing data for the invoice; and automatically send a response to the message, the response including the generated reconciled invoicing data for the invoice.

Alternatively, or in addition to the other examples described herein, examples include any combination of the following:
wherein the request to reconcile the one or more invoices is received in a first portion of the user interface and the reconciled invoicing data is outputted in a second portion of the user interface.
wherein the first invoicing data includes customer data, invoice data, and transactions data.
wherein the messages include one or more of an email message, an instant message, and a voice message.
wherein the attachments include one or more of an image and a portable document format (PDF) file;
receiving, via the user interface of the virtual assistant, a request to update the reconciled invoicing data; and based on the request to update the reconciled invoicing data, outputting, by the reconciliation agent, updated reconciled invoicing data in the user interface of the virtual assistant.
receiving, via the user interface of the virtual assistant, a request to generate a response to a user related to the reconciled invoicing data; and sending the generated response to the user related to the reconciled invoicing data.
analyzing the one or more of the messages and the attachments; based on the analyzing, determining that a response is requested by a user for an invoice of the one or more invoices; generating the response to the user for the invoice based on the reconciled invoicing data; and automatically sending the generated response to the user for the invoice.
wherein the invoice reconciliation service is triggered upon receiving a request from a virtual assistant.
wherein the instructions upon execution by the processor further cause the processor to: receive, via a user interface of the virtual assistant, a request to generate a response to the name of the customer related to the reconciled invoice; and send, by the email agent, the generated response to an address associated with the name of the customer related to the reconciled invoice.
wherein the message include one or more of an email message, an instant message, and a voice message.
wherein the attachment includes one or more of an image and a portable document format (PDF) file.
wherein the SQL query is generated for the request.
wherein the messaging application is one of an email application and an instant messaging application.
wherein the message includes one or more of an image and a portable document format (PDF) file.
wherein the instructions upon execution by the processor further cause the processor to: receive, via a virtual assistant, a user request from a user to reconcile the invoice, wherein the user request triggers the analyzing.
wherein the instructions upon execution by the processor further cause the processor to automatically trigger the analyzing periodically.

Any range or device value given herein may be extended or altered without losing the effect sought, as will be apparent to the skilled person.

Examples have been described with reference to data monitored and/or collected from the users (e.g., user identity data with respect to profiles). In some examples, notice is provided to the users of the collection of the data (e.g., via a dialog box or preference setting) and users are given the opportunity to give or deny consent for the monitoring and/or collection. The consent takes the form of opt-in consent or opt-out consent.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

It will be understood that the benefits and advantages described above may relate to one embodiment or may relate to several embodiments. The embodiments are not limited to those that solve any or all of the stated problems or those that have any or all of the stated benefits and advantages. It will further be understood that reference to ‘an’ item refers to one or more of those items.

The embodiments illustrated and described herein as well as embodiments not specifically described herein but within the scope of aspects of the claims constitute an exemplary means for detecting fraud transactions in peer-to-peer payments without an intermediary.

The term “comprising” is used in this specification to mean including the feature(s) or act(s) followed thereafter, without excluding the presence of one or more additional features or acts.

In some examples, the operations illustrated in the figures are implemented as software instructions encoded on a computer readable medium, in hardware programmed or designed to perform the operations, or both. For example, aspects of the disclosure are implemented as a system on a chip or other circuitry including a plurality of interconnected, electrically conductive elements.

The order of execution or performance of the operations in examples of the disclosure illustrated and described herein is not essential, unless otherwise specified. That is, the operations may be performed in any order, unless otherwise specified, and examples of the disclosure may include additional or fewer operations than those disclosed herein. For example, it is contemplated that executing or performing a particular operation before, contemporaneously with, or after another operation is within the scope of aspects of the disclosure.

When introducing elements of aspects of the disclosure or the examples thereof, the articles “a,” “an,” “the,” and “said” are intended to mean that there are one or more of the elements. The terms “comprising,” “including,” and “having” are intended to be inclusive and mean that there may be additional elements other than the listed elements. The term “exemplary” is intended to mean “an example of.” The phrase “one or more of the following: A, B, and C” means “at least one of A and/or at least one of B and/or at least one of C.”

Having described aspects of the disclosure in detail, it will be apparent that modifications and variations are possible without departing from the scope of aspects of the disclosure as defined in the appended claims. As various changes could be made in the above constructions, products, and methods without departing from the scope of aspects of the disclosure, it is intended that all matter contained in the above description and shown in the accompanying drawings shall be interpreted as illustrative and not in a limiting sense.

What is claimed is:

1. A computerized method for invoice reconciliation comprising:
receiving, via a user interface of a virtual assistant, a request to reconcile one or more invoices;
generating, by a data engineering agent, a structured query language (SQL) query;
executing, by the data engineering agent, the SQL query to obtain first invoicing data from a database;
obtaining, by an email agent, second invoicing data from one or more of messages and attachments;
reconciling, by a reconciliation agent, the first invoicing data and the second invoicing data to generate reconciled invoicing data; and
outputting, by the reconciliation agent, the reconciled invoicing data in the user interface of the virtual assistant.

2. The computerized method of claim 1, wherein the request to reconcile the one or more invoices is received in a first portion of the user interface and the reconciled invoicing data is outputted in a second portion of the user interface.

3. The computerized method of claim 1, wherein the first invoicing data includes customer data, invoice data, and transactions data.

4. The computerized method of claim 1, wherein the messages include one or more of an email message, an instant message, or a voice message.

5. The computerized method of claim 1, wherein the attachments include one or more of an image or a portable document format (PDF) file.

6. The computerized method of claim 1, further comprising:
receiving, via the user interface of the virtual assistant, a request to update the reconciled invoicing data; and
based on the request to update the reconciled invoicing data, outputting, by the reconciliation agent, updated reconciled invoicing data in the user interface of the virtual assistant.

7. The computerized method of claim 1, further comprising:
receiving, via the user interface of the virtual assistant, a request to generate a response to a user related to the reconciled invoicing data; and
sending the generated response to the user related to the reconciled invoicing data.

8. The computerized method of claim 1, further comprising:
analyzing the one or more of the messages and the attachments;
based on the analyzing, determining that a response is requested by a user for an invoice of the one or more invoices;
generating the response to the user for the invoice based on the reconciled invoicing data; and
automatically sending the generated response to the user for the invoice.

9. A system for invoice reconciliation comprising:
a processor; and
a memory storing instructions that upon execution by the processor cause the processor to:
trigger an invoice reconciliation service comprising a data engineering agent, an email agent, and a reconciliation agent;
identify, by the data engineering agent, an invoice data record associated with an invoice with an unpaid status from a database;
retrieve, by the data engineering agent, a name of customer from the identified invoice data record associated with the invoice with the unpaid status;
identify, by the email agent, a message associated with the name of the customer;
summarize, by the email agent, invoicing details from one or more of a body of the identified message and an attachment of the identified message;
determine, by the reconciliation agent, that the summarized invoicing details correspond to the invoice with the unpaid status; and
based on the determination, automatically update, by the reconciliation agent, the invoice data record in the database by changing the invoice as reconciled.

10. The system of claim 9, wherein the invoice reconciliation service is triggered periodically.

11. The system of claim 9, wherein the invoice reconciliation service is triggered upon receiving a request from a virtual assistant.

12. The system of claim 11, wherein the instructions upon execution by the processor further cause the processor to:
receive, via a user interface of the virtual assistant, a request to generate a response to the name of the customer related to the reconciled invoice; and
send, by the email agent, the generated response to an address associated with the name of the customer related to the reconciled invoice.

13. The system of claim 9, wherein the message includes one or more of an email message, an instant message, or a voice message.

14. The system of claim 9, wherein the attachment includes one or more of an image or a portable document format (PDF) file.

15. A computer storage medium storing instructions that upon execution by a processor cause the processor to:
analyze a message received in a messaging application;
based on the analyzing, determine that the message is a request for confirming reconciliation of an invoice;
execute, by a data engineering agent, a structured query language (SQL) query to obtain first invoicing data from a database for the request;
obtain, by an email agent, second invoicing data from the message;
reconciling, by a reconciliation agent, the first invoicing data and the second invoicing data to generate reconciled invoicing data for the invoice; and
automatically send a response to the message, the response including the generated reconciled invoicing data for the invoice.

16. The computer storage medium of claim 15, wherein the SQL query is generated for the request.

17. The computer storage medium of claim 15, wherein the messaging application is one of an email application or an instant messaging application.

18. The computer storage medium of claim 15, wherein the message includes one or more of an image or a portable document format (PDF) file.

19. The computer storage medium of claim 15, wherein the instructions upon execution by the processor further cause the processor to:
receive, via a virtual assistant, a user request from a user to reconcile the invoice, wherein the user request triggers the analyzing.

20. The computer storage medium of claim 15, wherein the instructions upon execution by the processor further cause the processor to automatically trigger the analyzing periodically.
